(19) United States
(12) Patent Application Publication
(10) Pub. No.: US 2008/0304109 A1
(43) Pub. Date: Dec. 11, 2008

(54) IMAGE-SORTING APPARATUS AND IMAGE-SORTING METHOD

(75) Inventors: Haruhiko Ishida, Tokyo (JP); Sunao Tabata, Mishima-shi (JP); Masao Yamaguchi, Tokyo (JP); Takahiro Fuchigami, Yokosuka-shi (JP); Hiroyuki Kato, Mishima-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/758,100

(22) Filed: Jun. 5, 2007

(51) Int. Cl. H04N 1/047

(52) U.S. Cl. 358/3.28; 358/1.14; 358/304; 358/505

(57) ABSTRACT

An image-sorting apparatus includes a feeding unit to feed printed sheets sequentially carried in from an external print unit, in which an electronic watermark is added to an important printed sheet. Particularly, the image-sorting apparatus includes a read unit to read the electronic watermark from the printed sheet fed by the feeding unit, and a control unit to control the feeding unit to feed the printed sheets to one of a first and a second transfer position based on a read result of the electronic watermark.

### BACKGROUND OF THE INVENTION

1. Field of the Invention

The present invention relates to a multi-function peripheral system used for printing various information, and particularly to an image-sorting apparatus and an image-sorting method in which important printed sheets are sorted.

2. Description of the Related Art

In recent years, many offices use computer terminals for managing various business information. As a result of this, there is increased opportunity to print the business information by a multi-function peripheral or a printer. Besides, the multi-function peripheral or the printer can be shared by plural computer terminals on a network.

As a recent change in social environment, it has been made mandatory for an enterprise with a certain scale to protect personal information capable of identifying a person. For example, a law office, a public office, an auxiliary organization of a public office, a local government, a bank, a life insurance company, a nonlife insurance company, or a stock company is an organization to handle the personal information in business, and other many organizations handle the personal information. Besides, the amendment and strengthening of the unfair competition prevention law is performed to strictly deal with the unfair acquisition of trade secrets by an enterprise. The trade secrets include, for example, customer information as an aggregate of personal information and business information such as planning information. Since there is a possibility that such business information leaks out from a computer terminal, the interest in the security has grown.

In offices, there is a case where business information is printed as, for example, material for a meeting. An important printed sheet requiring careful handling in view of confidentiality is collected after the meeting and is discarded by, for example, a shredder. However, in such an office, there is a case where a print requester forgets to take out a printed sheet discharged on a tray or container of a multi-function peripheral, or does not notice that double printing was erroneously performed and leaves part of printed sheets. Besides, there is a case where when a print requester collects printed sheets printed by his or her own request, he or she does not notice mixing of an important printed sheet printed by the request of another print requester. In this case, there is a risk that the important printed sheet is erroneously carried out to the outside of the company. Further, even if mixing of a printed sheet which is not requested is noticed, since the importance of the printed sheet is not recognized, careful handling can not be expected. That is, there is a risk that the mixed printed sheet is left at the place where it has been noticed, or it is discarded in a dust box.

Hitherto, there is known a printer system to prevent the leakage of secrets (see, for example, JP-A-2004-227216). In this printer system, plural terminal apparatuses to create print documents and a printer server to control a printer apparatus including a tray and a keyed box are provided on a network. A specific user has the right to output a confidential document, attaches a discharge destination designation code to designate the output to the keyed box and his or her own personal identifier to the confidential document and transmits it from the terminal apparatus to the printer server. The printer server recognizes the specific user by the personal identifier, and controls the printer apparatus so that the confidential document is discharged as the printed sheet to the keyed box designated by the discharge destination designation code. However, it is necessary to take out this printed sheet from the keyed box by using a key. Accordingly, although there does not arise a problem of security, an excellent collecting property that the printed sheet can be quickly collected can not be ensured. Besides, this printer system requires the printer server to perform special handling on the output of the confidential document in addition to the keyed box.

On the other hand, there is also proposed a technique to embed arbitrary information into image data for the purpose of obtaining security guarantee and copyright protection (see, for example, JP-A-2005-269055). In this technique, an image processing apparatus prints image data to which arbitrary information is added in the form of a character string, a bar code or an electronic watermark so as to be capable of identifying the apparatus itself or a user, or transmits it to an equipment on a network. In the foregoing document, the arbitrary information embedded in the image data is checked in order to confirm unfair possession.

Further, at present, a multi-function peripheral having a private print function has appeared. In this private print function, the multi-function peripheral performs printing only in the case where the user can directly collect printed sheets. The user selects the private print function from the computer terminal to perform the print instruction, and then moves to the front of the multi-function peripheral, and starts the printing by further performing a procedure operation, such as input of a registration number, through an operation panel of the multi-function peripheral. Although the private print function does not cause a problem on security, the troublesome operation at the multi-function peripheral is required in addition to the print request at the computer terminal. Thus, similarly to the case of using the keyed box, the printed sheet can not be quickly collected. Besides, although the private print function can be set by default in the computer terminal, each time there arises a necessity to shift to a normal print function, a troublesome operation to temporarily release the setting is required.

As described above, when importance is attached to the security, it can not be avoided that the collection of printed sheets becomes difficult, or the structure at the print unit side becomes complicated.

### BRIEF SUMMARY OF THE INVENTION

An object of the invention is to provide an image-sorting apparatus and an image-sorting method in which without requiring a structure change of a print unit side, an excellent collecting property is ensured, and the security of an important printed sheet can be improved.

According to the invention, there is provided an image-sorting apparatus including a feeding unit to feed printed sheets sequentially carried in from an external print unit, in which an important mark is added to an important printed sheet, a read unit to read the important mark from the printed sheet fed by the feeding unit, and a control unit to control the feeding unit to feed the printed sheets to one of a first and a second transfer position based on a read result of the important mark.

Besides, according to the invention, there is provided an image-sorting method including adding an important mark to an important printed sheet, reading the important mark from printed sheets sequentially carried in from an external print unit, and feeding the printed sheets to one of a first and a second transfer position based on a read result of the important mark.

In the image-sorting apparatus and the image-sorting method, the printed sheets sequentially carried in from the external print unit are classified into important printed sheets and unimportant printed sheets based on the reading result of the important mark, and are respectively fed to the first transfer and the second transfer position. Thus, it is avoided that the important printed sheets, together with the unimportant printed sheets later printed, are collected. Besides, the easiness of the collection is not impaired. The important mark can be embedded as, for example, an electronic watermark in the image data for printing by a computer terminal or the like, and it is not necessary to provide a structure for classifying printed sheets into important printed sheets and unimportant printed sheets at the print unit side. By the foregoing structure, without requiring a structure change of the print unit side, the excellent collecting property is ensured and the security of the important printed sheet can be improved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view showing a structure of a multi-function peripheral system of a first embodiment of the invention;

FIG. 2 is a view showing a circuit structure of a finisher shown in FIG. 1;

FIG. 3 is a flowchart showing a control processing performed by a control unit shown in FIG. 2;

FIG. 4 is a sectional view showing a structure of a multi-function peripheral system of a second embodiment of the invention;

FIG. 5 is a view showing a circuit structure of a finisher shown in FIG. 4;

FIG. 6 is a flowchart showing a first control processing performed by a control unit shown in FIG. 5; and

FIG. 7 is a flowchart showing a second control processing performed by the control unit shown in FIG. 5.

### DETAILED DESCRIPTION OF THE INVENTION

Hereinafter, a multi-function peripheral system of a first embodiment of the invention will be described with reference to the accompanying drawings.

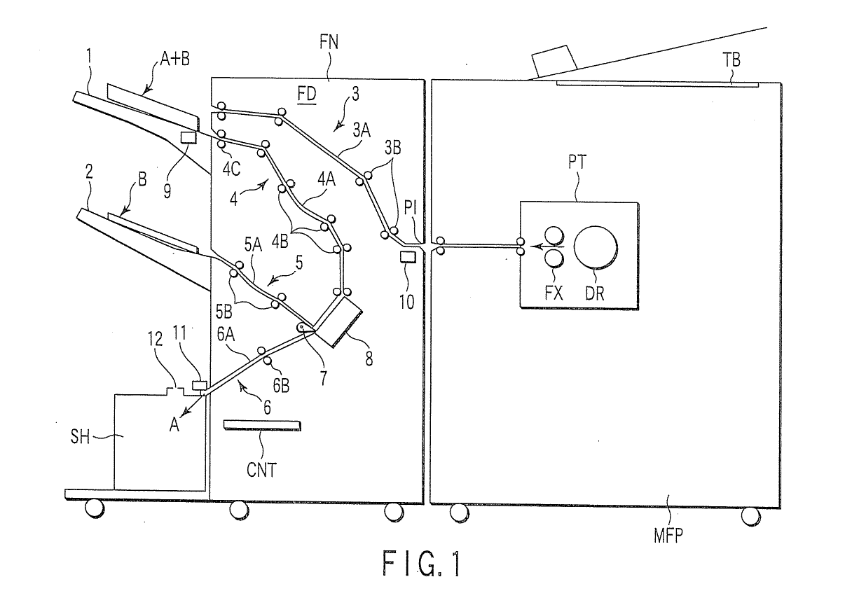

FIG. 1 shows a structure of the multi-function peripheral system. As shown in FIG. 1, this multi-function peripheral system includes a multi-function peripheral MFP and a finisher FN. The multi-function peripheral MFP is an image forming apparatus which, together with plural computer terminals (not shown) to manage various business information in an office, is connected to, for example, a local area network (LAN) and is shared by these computer terminals. The multi-function peripheral MFP has, for example, a printer function to print image data transmitted from the computer terminal, a scanner function to read an image from an original document on an original document stand and to convert it into image data, a copy function to print the image data obtained by the scanner function, and a FAX function to fax the image data obtained by the scanner function. In the multi-function peripheral MFP, a print unit PT of a xerographic system is provided to perform color or monochrome printing of image data. In the print unit PT, an electrostatic latent image corresponding to the image data is formed on an image bearing body DR, toner is selectively attached to the electrostatic latent image to develop it into a toner image, the toner image is fixed to a sheet by a fixing unit FX, and a printed sheet obtained by this is carried out.

The finisher FN is an image-sorting apparatus provided as an option of the multi-function peripheral MFP, and includes a feeding unit FD to feed printed sheets sequentially carried in from the print unit PT, to discharge and stack them on an upper tray 1 arranged at a discharge position, and to further feed the printed sheets on the upper tray 1 to one of a shredder SH arranged at a first transfer position and a middle tray 2 arranged at a second transfer position. The shredder SH is disposed below the middle tray and is exposed to the outside. The feeding unit FD includes a feeding mechanism unit 3 to feed the printed sheet from the print unit PT to the upper tray 1, a feeding mechanism 4 to take in the printed sheets stacked on the upper tray 1 one by one and to feed them, a feeding mechanism 5 to feed the printed sheet to the middle tray 2, a feeding mechanism 6 to feed the printed sheet to the shredder SH, and a path switching unit 7 to switch a path of the printed sheet fed by the feeding mechanism 4 to one of the feeding mechanism 5 and the feeding mechanism 6 by a movable plate.

The feeding mechanism 3 includes a feeding path 3A disposed between a carrying-in port PI and the upper tray 1, and a feeding roller group 3B disposed along the feeding path 3A. The feeding mechanism 4 includes a feeding path 4A disposed between the upper tray 1 and the path switching unit 7, a feeding roller group 4B disposed along the feeding path 4A, and a pickup roller 4C to take in the printed sheet from the upper tray 1. The feeding mechanism 5 includes a feeding path 5A disposed between the path switching unit 7 and the middle tray 2, and a feeding roller group 5B disposed along the feeding path 5A. The feeding mechanism 6 includes a feeding path 6A disposed between the path switching unit 7 and the shredder SH, and a feeding roller group 6B disposed along the feeding path 6A. The shredder SH is an example of an erasing equipment to erase the print content of the printed sheet, and is constructed not only to cut the printed sheet carried in by the feeding mechanism 6 into small pieces, but also to cut an arbitrary printed sheet put in a slot 12 into small pieces.

The finisher FN further includes a read unit 8 to read an electronic watermark as an important mark added to the printed sheet fed by the feeding mechanism 4, and a control unit CNT to control the feeding unit FD based on the read result of the electronic watermark by the read unit 8. The read unit 8 is constructed by using a charge-coupled device (CCD) type image sensor. In this finisher FN, a sheet sensor 9, a passing sensor 10 and a passing sensor 11 are provided as part of the control unit CNT. The sheet sensor 9 is attached to the upper tray 1 in order to detect the printed sheet discharged onto the upper tray 1. The passing sensor 10 is disposed in the vicinity of the carrying-in port PI in order to detect the passing of the printed sheet carried in from the multi-function peripheral MFP. The passing sensor 11 is disposed in the vicinity of the carrying-in port of the shredder SH in order to detect the passing of the printed sheet carried into the shredder SH by the feeding mechanism 6.

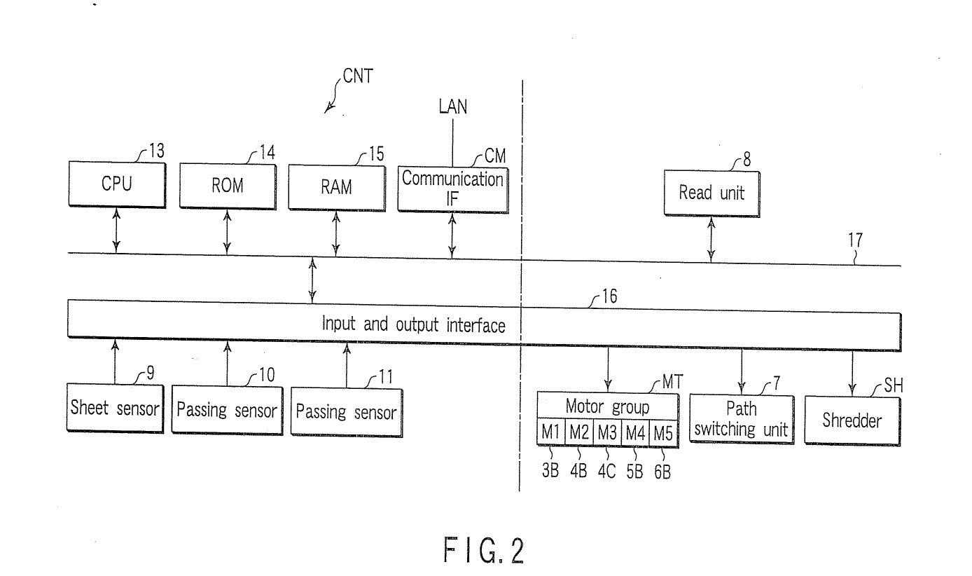

FIG. 2 shows a circuit structure of the finisher FN. In addition to the sensors 9 to 11, the control unit CNT includes a CPU 13, a ROM 14, a RAM 16, a communication interface CM, and an input and output interface 16. The CPU 13 is connected to the ROM 14, the RAM 15, the read unit 8, the communication interface CM6, and the input and output interface 1 through a bus line 17, and performs a control to sort the printed sheets. The CPU 13 has a timer function to detect the passage of various specified times. The ROM 14 is used for storing a control program of the CPU 13 and fixed data. The RAM 15 is used for temporarily storing input and output data of the CPU 13. The communication interface CM interfaces plural computer terminals existing on the same LAN as that of the multi-function peripheral MFP with the CPU 13. The CPU 13 causes the communication interface CM to function in the transmission of a mail to notify the processing state (status) of a printed sheet added with an electronic watermark to a print requester as a user of a computer terminal, and in the enquiry of the processing state (status) of a printed sheet added with an electronic watermark from these computer terminals. The input and output interface 16 interfaces peripheral devices, such as the sheet sensor 9, the passing sensor 10, the passing sensor 11, the pass switching unit 7, the shredder SH and a motor group MT, with the CPU 13. The motor group MT includes, for example, motors M1 to M5 to respectively drive a feeding roller 3B, a feeding roller 4B, a pickup roller 4C, a feeding roller 5B and a feeding roller 6B. Incidentally, in FIG. 1, these motors M1 to M5 are schematically shown.

The computer terminal on the LAN creates various documents (papers) based on business information in data processing executed by performing, for example, application software for document creation or for table calculation. These documents include not only normal documents but also confidential documents. A normal printing software driver conforming to the multi-function peripheral MFP and an “electronic watermark” printing software driver are previously set in the computer terminal. The result of the data processing is converted into image data of a print format depending on the selected software driver, and is transmitted to the multi-function peripheral MFP. The “electronic watermark” printing software driver is selected in the case where the confidential document is printed, and the normal printing software driver is selected in the case where the normal document is printed. The “electronic watermark” printing driver transmits image data in which user information is embedded as an electronic watermark, which can not be confirmed with the naked eye in the print result and does not substantially disturb the document image, to the multi-function peripheral MFP. The user information includes a mail address to enable identification of a print requester, a print date and the like. The normal printing driver transmits image data in which user information as an electronic watermark is not embedded to the multi-function peripheral MFP. When the image data of the normal document or the confidential document is transmitted from the computer terminal on the network to the multi-function peripheral MFP, the print unit PT performs a print operation based on this image data. The printed sheet of the print result is fed from the print unit PT to the finisher FN.

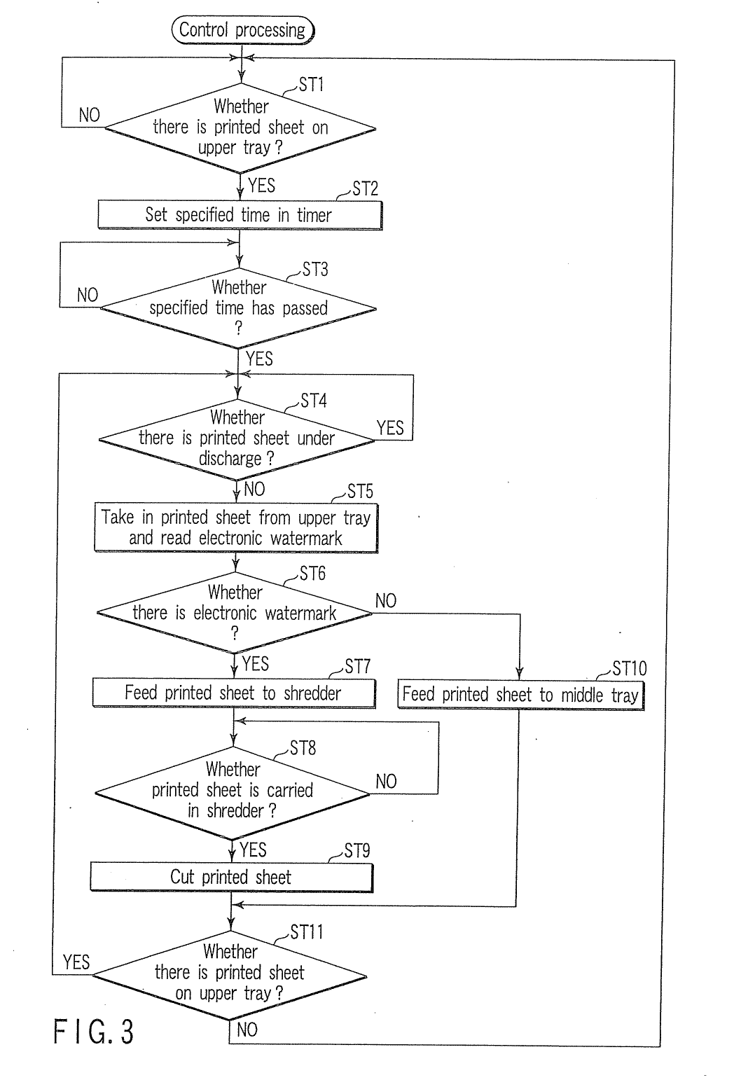

FIG. 3 shows a control processing performed by the control unit CNT of the finisher FN. When the printed sheet is carried in the finisher FN, it is discharged facedown to the upper tray 1 by the feeding mechanism 3. At step ST1, it is checked whether there is a printed sheet on the upper tray 1. When there is no printed sheet, the step ST1 is repeatedly performed. When the printed sheet is discharged onto the upper tray 1, this is detected by the sheet sensor 9. Subsequently to this, a specified time of, for example, 5 minutes is set in a timer at step ST2. At step ST3, it is checked whether the specified time has passed. The step ST3 is repeated until the passage of the specified time is detected. When the passage of the specified time is detected, at step ST4, it is checked whether there is a printed sheet under discharge onto the upper tray 1. In the state where the passing sensor 10 sequentially detects the passage of printed sheets, it is regarded that there is a printed sheet under discharge, and the step ST4 is repeated. When the passage of a printed sheet comes not to be detected, it is regarded that there is no printed sheet under discharge, and step ST5 is performed. At the step ST5, the printed sheet on the upper tray 1 is taken in by the feeding mechanism 4 one by one and is fed to the read unit 8. The read unit 8 reads an electronic watermark from the printed sheet. In this reading, the image of the printed sheet is converted into image data by a CCD, and extraction of the electronic watermark is performed with respect to this image data. In the case where the electronic watermark can be extracted, user information is reproduced from this electronic watermark and is stored in the RAM 15. At subsequent step ST6, it is checked whether there is an electronic watermark. When there is an electronic watermark, the path of the printed sheet is set to the feeding mechanism 6 by the path switching unit 7 at step ST7, and this printed sheet is fed to the shredder SH by the feeding mechanism 6. At step ST8, it is checked whether this printed sheet has been carried in the shredder SH. The step ST8 is repeated until the passing sensor 11 detects the passing of the printed sheet. When the carrying-in to the shredder SH is confirmed from the detection result of the passing sensor 11, the shredder SH is driven at step ST9, and the printed sheet is cut into small pieces. At this time, the execution state of the cutting is correlated with the user information corresponding to this printed sheet and is stored in the RAM 15. Further, a mail to notify that the cutting of the printed sheet has been performed may be transmitted to the mail address included in the user information. Incidentally, when it is confirmed at the step ST6 that there is no electronic watermark, the path of the printed sheet is set to the feeding mechanism 5 by the path switching unit 7 at step ST10, and this printed sheet is fed to the middle tray 2 by the feeding mechanism 6. When the step ST9 or ST10 is performed, it is next checked at step ST11 whether there is a printed sheet on the upper tray 1. When the sheet sensor 9 detects the printed sheet on the upper tray 1, in order to handle also the printed sheet left on the upper tray 1 similarly to the above, the steps ST4 to ST11 are repeated. As a result, when a printed sheet comes not to exist on the upper tray 1, the step ST1 is repeated until a printed sheet from the print unit PT is again discharged to the upper tray 1.

Here, when a first print requester requests the multi-function peripheral MFP to print confidential documents A from a computer terminal on the LAN, the print unit PT of the multi-function peripheral MFP sequentially prints, as the confidential documents A, one or more printed sheets to which the electronic watermark is added for the print requester. These printed sheets are carried in the finisher FN from the print unit PT at almost constant intervals. The finisher FN sequentially discharges the printed sheets of the confidential documents A to the upper tray 1. When the first print requester moves to the installation place of the multi-function peripheral MFP immediately after the print request, the printed sheets of the confidential documents A can be collected from the upper tray 1. When a second print requester requests the multi-function peripheral MFP to print normal documents B from a computer terminal on the LAN within 5 minutes from the first discharge of the printed sheet of the confidential document A to the upper tray 1, the print unit PT of the multi-function peripheral MFP sequentially prints, as the normal documents B, one or more printed sheets to which an electronic watermark is not added. These printed sheets are also carried in the finisher FN from the print unit PT at almost constant intervals. The finisher FN sequentially discharges the printed sheets of the normal documents B to the upper tray 1. When the first print requester does not collect the confidential documents A, the normal documents B are stacked on the confidential documents A on the upper tray 1. Since the amount of printed sheets printed in about 5 minutes is relatively small, even if which of the print requesters first comes to the multi-function peripheral MFP, the confidential documents A and the normal documents B are easily differentiated and can be collected.

When the first print requester does not come to collect the confidential documents A within 5 minutes, the confidential documents A are fed one by one from the upper tray 1 to the read unit 8. It is confirmed by the read unit 8 that these confidential documents A have the electronic watermarks, and they are fed to the shredder SH and are cut into small pieces by the shredder SH. Accordingly, even if the first print requester forgets to collect the confidential documents A, the security of the confidential documents A is ensured. Besides, when the normal documents B, together with the confidential documents A, are left on the upper tray 1, the confidential documents B are also fed one by one from the upper tray 1 to the read unit 8. Since it can not be confirmed by the read unit 8 that these normal documents B have electronic watermarks, they are fed to the middle tray 2. Accordingly, even if the second print requester can not come to collect the normal documents B immediately, since these normal documents B are left on the middle tray 2, the normal documents B can be collected without problem.

In the multi-function peripheral system of this embodiment, the printed sheets discharged from the print unit PT to the upper tray 1 at the discharge position are classified into the confidential documents A (important printed sheets) and the unimportant printed sheets (normal documents B) based on the read result of the electronic watermark as the important mark after the specified time of 5 minutes, and they are respectively fed to the shredder SH at the first transfer position and the middle tray 2 at the second transfer position. Thus, even if the important printed sheets are not collected within the specified time but are left, it is avoided that the important printed sheets, together with the unimportant printed sheets later printed, are collected. Besides, the easiness of the collection is not impaired. The electronic watermark can be embedded in the image data for printing by the computer terminal side by selecting the “electronic watermark” printing software driver, and it is unnecessary to provide a structure to classify printed sheets into important printed sheets and unimportant printed sheets at the print unit PT side. Further, the user information obtained from the electronic watermark, together with the status of the important printed sheet, is stored, the print requester and the print time of the important printed sheet can be confirmed by an inquiry from the computer terminal or mail transmission, and it can also be confirmed that this printed sheet has been cut. By the foregoing structure, the excellent collecting property is ensured without requiring the structure change of the print unit side, and the security of the important printed sheet can be improved.

Hereinafter, a multi-function peripheral system of a second embodiment of the invention will be described with reference to the accompanying drawings.

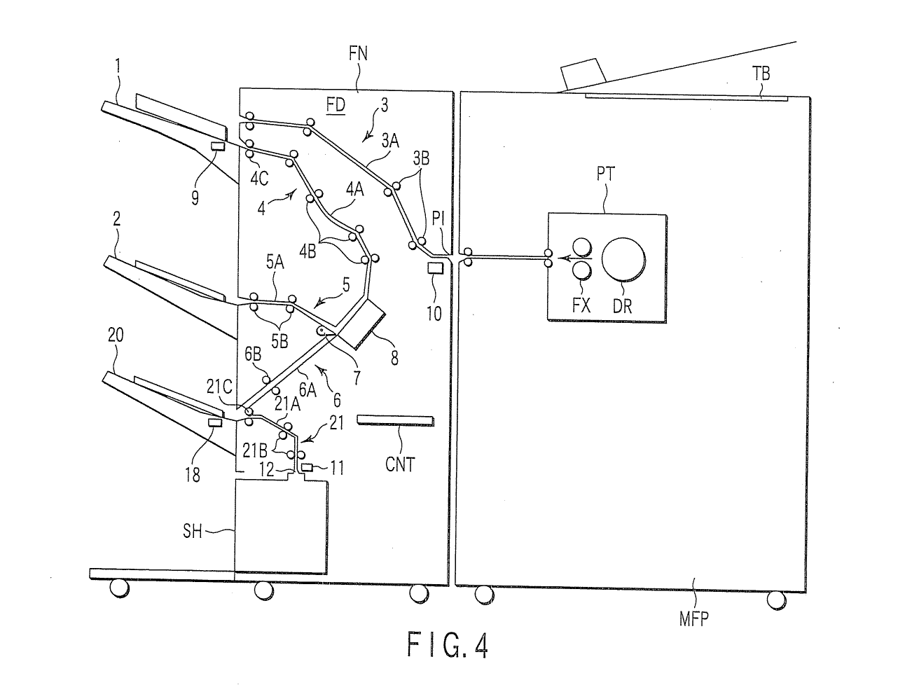

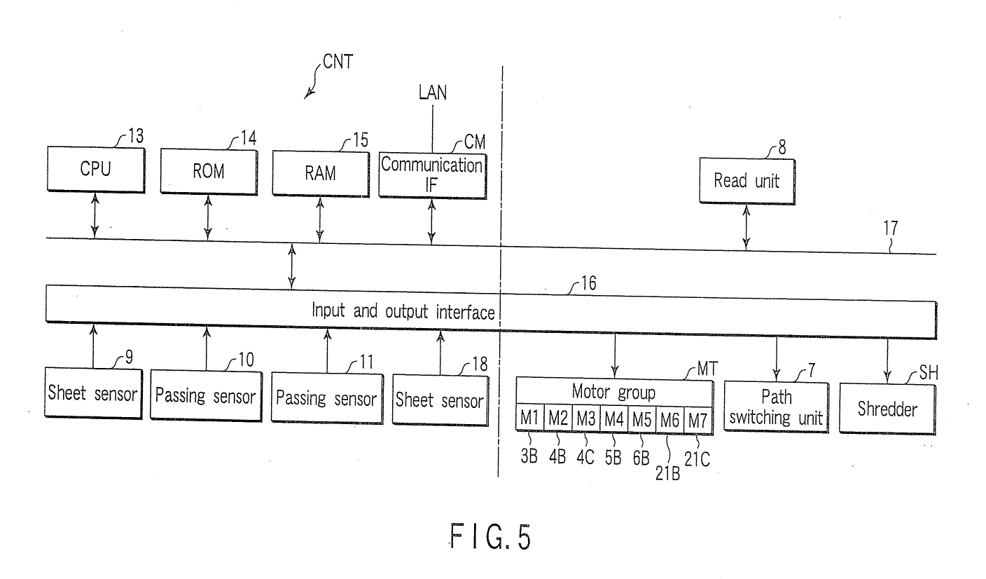

FIG. 4 shows a structure of the multi-function peripheral system, and FIG. 5 shows a circuit structure of a finisher FN shown in FIG. 4. The multi-function peripheral system is constructed similarly to the first embodiment except for the following. In FIG. 4 and FIG. 5, the same portions as those of the first embodiment are denoted by the same reference characters, and their explanation will be omitted. In the second embodiment, a lower tray 20 is disposed below a middle tray 2. A sheet sensor 18 is attached to the lower tray 20 to detect a printed sheet discharged on the lower tray 20. A shredder SH is contained in the inside of the finisher FN, and the position of the shredder SH is set to a third transfer position. A feeding mechanism 6 is constructed to feed a printed sheet guided by a path switching unit 8 to the lower tray 20. In the feeding mechanism 6, the feeding path 6A is disposed between the path switching unit 7 and the shredder SH, and a feeding roller 6B is disposed along the feeding path 6A. A feeding mechanism 7 is provided to feed the printed sheet discharged on the lower tray 20 to the shredder SH. In this feeding mechanism 7, a feeding path 21A is disposed between the lower tray 20 and the shredder SH, a feeding roller 21B is disposed along the feeding path 21A, and a pickup roller 21C is provided to take out printed sheets on the lower tray 21 one by one. A passing sensor 11 is disposed in the vicinity of a slot 12 of the shredder SH in order to detect the passing of the printed sheet carried in the shredder SH by the feeding mechanism 7. The feeding roller 21B and the pickup roller 21C are driven by motors M6 and M7 added to a motor group MT as shown in FIG. 5. The sheet sensor 18 is connected to an input and output interface 16 as shown in FIG. 5.

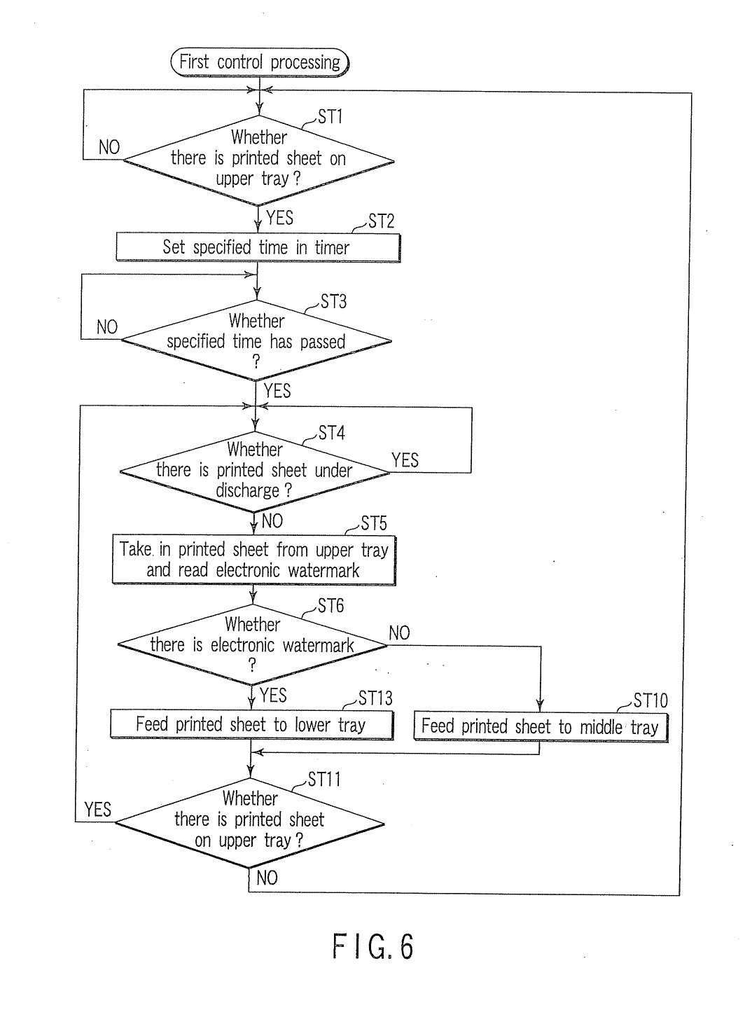

FIG. 6 shows a first control processing performed by a control unit CNT shown in FIG. 5. The first control processing is the same as the control processing of the first embodiment except that step ST13 is provided instead of the steps ST7 to ST9 shown in FIG. 3. Thus, the same portions as those of FIG. 3 are denoted by the same reference characters and their explanation will be omitted. In the second embodiment, when it is detected at step ST6 by the read unit 8 that there is an electronic watermark as an important mark, the path of the printed sheet is set to the feeding mechanism 6 at step ST13 by the path switching unit 7, and this printed sheet is fed to the lower tray 20 by the feeding mechanism 6. Thereafter, it is checked at step ST11 whether there is a printed sheet on an upper tray 1. When a sheet sensor 9 detects the printed sheet on the upper tray 1, in order to perform the foregoing handling also on the printed sheet left on the upper tray 1, steps ST4, ST5, ST6, ST13, ST10 and ST11 are repeated. As a result, when a printed sheet comes not to exist on the upper tray 1, step ST1 is repeated until a printed sheet from the print unit PT is again discharged to the upper tray 1.

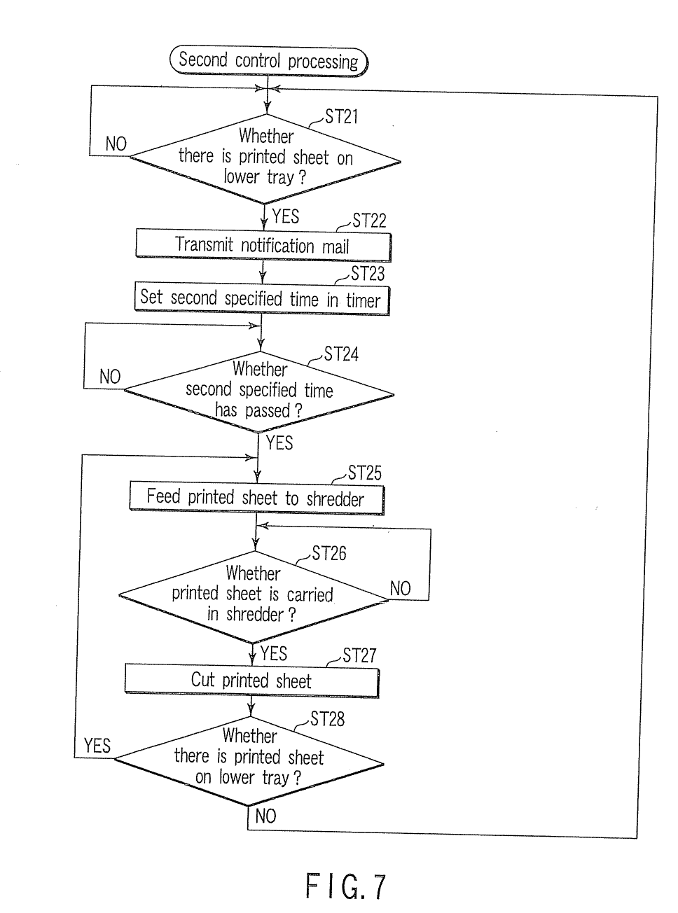

The control unit CNT shown in FIG. 5 performs a second control processing shown in FIG. 7 in parallel to the first control processing. In this second control processing, it is checked at step ST21 whether there is a printed sheet on the lower tray 20. When there is no printed sheet, the step ST21 is repeatedly performed. When a printed sheet is discharged onto the lower tray 20, this is detected by the sheet sensor 18. Subsequently to this, at step ST22, a mail address of a print requester of this printed sheet is acquired from user information of the read result of the electronic watermark, and a mail is transmitted to the acquired mail address in order to notify that the printed sheet has been fed to the lower tray 20 and this printed sheet is to be cut into small pieces after a second specified time set to, for example, 5 minutes. Further, at step ST23, the foregoing second specified time is set in a timer. At step ST24, it is checked whether this second specified time has passed. The step ST24 is repeated until the passage of the second specified time has detected. When the second specified time has passed, at step ST25, the printed sheets on the lower tray 20 are taken in one by one by the feeding mechanism 7 and are fed to the shredder SH. At step ST26, it is checked whether the printed sheet has been carried in the shredder SH. The step ST26 is repeated until the passing sensor 11 detects the passing of the printed sheet. When the carrying-in to the shredder SH is confirmed from the detection result of the passing sensor 11, the shredder SH is driven at step ST27, and the printed sheet is cut into small pieces. At this time, the execution state of the cutting is correlated with the user information corresponding to this printed sheet and is stored in a RAM 15. Here, a mail to notify that the cutting of the printed sheet has been performed may be transmitted to the mail address included in the user information. Subsequently to the step ST27, it is checked at step ST28 whether there is a printed sheet on the lower tray 20. When the sheet sensor 18 detects the printed sheet on the lower tray 20, in order to perform the foregoing handling also on the printed sheet left on the lower tray 20, the steps ST25 to ST28 are repeated. As a result, when a printed sheet comes not to exist on the lower tray 20, the step ST21 is repeated until a printed sheet is again discharged to the lower tray 20.

Here, when a first print requester requests the multi-function peripheral MFP to print confidential documents A from a computer terminal on a LAN, the print unit PT of the multi-function peripheral MFP sequentially prints, as the confidential documents A, one or more printed sheets added with electronic watermarks for the print requester. These printed sheets are carried in the finisher FN from the print unit PT at almost constant intervals. The finisher FN sequentially discharges the printed sheets of the confidential documents A to the upper tray 1. When the first print requester moves to the installation place of the multi-function peripheral MFP immediately after the print request, the printed sheets of the confidential documents A can be collected from the upper tray 1. When a second print requester requests the multi-function peripheral MFP to print normal documents B from a computer terminal on the LAN within a specified time (first specified time) of 5 minutes from the first discharge of the printed sheet of the confidential document A to the upper tray 1, the print unit PT of the multi-function peripheral MFP sequentially prints, as the normal documents B, one or more printed sheets to which an electronic watermark is not added. These printed sheets are also carried in the finisher FN from the print unit PT at almost constant intervals. The finisher FN sequentially discharges the printed sheets of the normal documents B to the upper tray 1. When the first print requester does not collect the confidential documents A, the normal documents B are stacked on the confidential documents A on the upper tray 1. Since the amount of printed sheets printed in the time of about 5 minutes is relatively small, even if which of the print requesters first comes to the multi-function peripheral MFP, the confidential documents A and the normal documents B are easily discriminated and can be collected.

When the first print requester does not come to collect the confidential documents A within the first specified time of 5 minutes, the confidential documents A are fed to the read unit 8 one by one from the upper tray 1. It is confirmed by the read unit 8 that these confidential documents A have electronic watermarks, and they are fed to the lower tray 20SH. Accordingly, even if the first print requester can not come to collect the confidential documents A immediately, since the confidential documents A are left on the lower tray 20, the confidential documents A can be collected without problem. Besides, when the normal documents B, together with the confidential documents A, are left on the upper tray 1, the confidential documents B are also fed one by one from the upper tray 1 to the read unit 8. Since it can not be confirmed by the read unit 8 that these normal documents B have electronic watermarks, they are fed to the middle tray 2. Accordingly, even if the second print requester can not come to collect the normal documents B immediately, since the normal documents B are left on the middle tray 2, the normal documents B can be collected without problem. That is, when the first specified time of 5 minutes has passed, since the confidential documents A and the normal documents B are respectively fed to the places different from each other, that is, the lower tray 21 and the middle tray 2, it can be avoided that the confidential documents A, together with the normal documents B, are erroneously collected.

Besides, the confidential documents A are discharged to the lower tray 20, and when the first print requester does not come to collect the confidential documents A even if the second specified time of 5 minutes has passed, the confidential documents A are fed one by one from the lower tray 20 to the shredder SH and are cut into small pieces by the shredder SH. Accordingly, even if the first print requester forgets to collect the confidential documents A, the security of the confidential documents A is ensured.

In the multi-function peripheral system of the second embodiment, the printed sheets discharged to the upper tray 1 at the discharge position from the print unit PT are classified into the confidential documents A (important printed sheets) and the unimportant printed sheets (normal documents B) based on the read result of the electronic watermark as the important mark after the first specified time of 5 minutes, and are respectively fed to the lower tray 20 at the first transfer position and the middle tray 2 at the second transfer position. Thus, even if the important printed sheets are not collected within the specified time but are left as they are, it can be avoided that the important printed sheets, together with the unimportant printed sheets later printed, are collected. Besides, the easiness of the collection is not impaired. Further, after the second specified time, all the important printed sheets are fed from the lower tray 20 to the shredder SH at the third transfer position. Accordingly, the security of the important printed sheets can be ensured. Besides, similarly to the first embodiment, the electronic watermark can be embedded in the image data for printing at the computer terminal side by selecting an “electronic watermark” printing software driver, and it is not necessary that a structure to classify printed sheets into important printed sheets and unimportant printed sheets is provided at the print unit side PT. Further, since the user information obtained from the electronic watermark, together with the status of the important printed sheet, is stored, the print requester and print time of the important printed sheet can be confirmed by enquiry from the computer terminal or mail transmission, and further, it can also be confirmed that the printed sheet has been cut. By the structure as stated above, the excellent collecting property is ensured without requiring the structure change of the print unit side, and the security of the important printed sheet can be improved.

Incidentally, in the first and the second embodiment, although the important printed sheet is automatically cut by the shredder SH after the specified time has passed, this shredder SH may be replaced by another erasing equipment which can erase the print content.

Besides, although the electronic watermark is added to only the important printed sheet, the electronic watermark may be added to all printed sheets (that is, the confidential document A and the normal document B), while the user information is made to include the level of importance of the printed sheet. In this case, a structure is made such that the control unit CNT determines the transmission destination of the printed sheet based on the level of importance of the printed sheet represented by the electronic watermark read from the printed sheet.

Besides, although both the first and the second specified time are set to 5 minutes, these may be respectively set to arbitrary times according to the print frequency of the important printed sheet.

Besides, the upper tray 1, the middle tray 2, and the lower tray 20 are respectively independently used as examples of holding members to hold the printed sheets. The arrangement of the holding members in the vertical direction and their shapes are arbitrary. Accordingly, the trays 1, 2 and 20 may be changed to, for example, a container (bin) to contain printed sheets.

Besides, in addition to the structure in which the printed sheets are classified after the printed sheets are once discharged and stacked to the discharge position, a structure may be made such that the printed sheet is made to pass through the read unit to read the electronic watermark before it is discharged to the discharge position, the feeding path is branched based on the read result of the electronic watermark, and the important printed sheet and the unimportant printed sheet are discharged to different discharge positions. Also in this case, the excellent collecting property is ensured without requiring the structure change of the print unit side, and the security of the important printed sheet can be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image-sorting apparatus comprising:
a feeding unit to feed printed sheets sequentially carried in from an external print unit, in which an important mark is added to an important printed sheet;
a read unit to read the important mark from the printed sheet fed by the feeding unit; and
a control unit to control the feeding unit to feed the printed sheets to one of a first and a second transfer position based on a read result of the important mark.

2. The image-sorting apparatus according to claim 1, wherein the control unit controls the feeding unit to feed the printed sheet having the important mark to the first transfer position and to feed the printed sheet having no important mark to the second transfer position.

3. The image-sorting apparatus according to claim 2, further comprising an erasing equipment to erase print content of the printed sheet fed to the first transfer position, and a hold member to hold the printed sheet fed to the second transfer position,
wherein the control unit controls the feeding unit to discharge and stack the printed sheets from the print unit to a discharge position, and to feed the printed sheets one by one from the discharge position to the read position after a specified time has passed.

4. The image-sorting apparatus according to claim 3, wherein the erasing equipment is a shredder to cut the printed sheet into small pieces.

5. The image-sorting apparatus according to claim 2, wherein the control unit controls the feeding unit to feed the printed sheets one by one from the first transfer position to a third transfer position after at least a specified time has passed since the printed sheets were fed to the first transfer position.

6. The image-sorting apparatus according to claim 5, further comprising a first hold member to hold the printed sheet fed to the first transfer position, a second hold member to hold the printed sheet fed to the second transfer position, and an erasing equipment to erase print content of the printed sheet fed to the third transfer position.

7. The image-sorting apparatus according to claim 6, wherein the erasing equipment is a shredder to cut the printed sheet into small pieces.

8. The image-sorting apparatus according to claim 1, wherein the important mark is an electronic watermark.

9. The image-sorting apparatus according to claim 8, wherein the electronic watermark represents user information of the printed sheet, and the control unit correlates a processing state of the printed sheet with the user information acquired as a read result of the electronic watermark and stores the processing state.

10. The image-sorting apparatus according to claim 9, wherein the control unit notifies the processing state of the printed sheet to a user specified from the user information.

11. An image-sorting method comprising:
adding an important mark to an important printed sheet;
reading the important mark from printed sheets sequentially carried in from an external print unit; and
carrying the printed sheets to one of a first and a second transfer position based on a read result of the important mark.

12. The image-sorting method according to claim 11, wherein the printed sheet having the important mark is fed to the first transfer position and the printed sheet having no important mark is fed to the second transfer position.

13. The image-sorting method according to claim 12, further comprising:
discharging and stacking the printed sheets from the print unit to a discharge position;
carrying the printed sheets one by one from the discharge position after a specified time has passed;
erasing print content of the printed sheet fed to the first transfer position by an erasing equipment; and
holding the printed sheet fed to the second transfer position by a holding member.

14. The image-sorting method according to claim 13, wherein the erasing equipment is a shredder to cut the printed sheet into small pieces.

15. The image-sorting method according to claim 12, wherein the printed sheets are carried one by one from the first transfer position to a third transfer position after at least a specified time has passed since the printed sheets were fed to the first transfer position.

16. The image-sorting method according to claim 15, further comprising:
holding the printed sheet fed to the first transfer position by a first hold member;
holding the printed sheet fed to the second transfer position by a second hold member; and
erasing print content of the printed sheet fed to the third transfer position by an erasing equipment.

17. The image-sorting method according to claim 16, wherein the erasing equipment is a shredder to cut the printed sheet into small pieces.

18. The image-sorting method according to claim 11, wherein the important mark is an electronic watermark.

19. The image-sorting method according to claim 18, wherein the electronic watermark represents user information of the printed sheet, and a processing state of the printed sheet is correlated with the user information acquired as a read result of the electronic watermark and is stored.

20. The image-sorting method according to claim 19, wherein the processing state of the printed sheet is notified to a print requester specified from the user information.
